(19) United States
(12) Patent Application Publication
(10) Pub. No.: US 2019/0378632 A1
(43) Pub. Date: Dec. 12, 2019

(54) PLATED PRODUCT AND METHOD OF MANUFACTURING THE SAME

(71) Applicant: Cheng Uei Precision Industry Co., Ltd., New Taipei City (TW)

(72) Inventors: CHIU-HSIEN YANG, New Taipei City (TW); QI-WEN XIAO, Dong-Guan City (CN); PENG LI, Dong-Guan City (CN)

(21) Appl. No.: 16/410,970

(22) Filed: May 13, 2019

(30) Foreign Application Priority Data
Jun. 11, 2018 (CN) 201820894852.3

(51) Int. Cl. H01B 1/02; H01R 13/03; C23C 18/32; C23C 18/38; C23C 18/42

(52) U.S. Cl. CPC H01B 1/02; H01R 13/03; C23C 18/42; C23C 18/38; C23C 18/32

(57) ABSTRACT

A plated product includes a component and an overall layer plated on a surface of the component. The overall layer includes a copper layer, a nickel layer, a nickel-tungsten layer, an inner golden layer, a palladium layer, an outer golden layer and a rhodium-ruthenium layer. The copper layer is plated on a surface of the component. The nickel layer, the nickel-tungsten layer, the inner golden layer, the palladium layer, the outer golden layer and the rhodium-ruthenium layer are plated on a surface of the copper layer in sequence.

### CROSS-REFERENCE TO RELATED APPLICATION

The present application is based on, and claims priority from, China Patent Application No. 201820894852.3, filed Jun. 11, 2018, the disclosure of which is hereby incorporated by reference herein in its entirety.

### BACKGROUND OF THE INVENTION

### 1. Field of the Invention

The present invention generally relates to a plated product, and more particularly to a plated product having an abrasion resistance performance and a corrosion resistance performance, and a method of manufacturing the plated product.

### 2. The Related Art

With the increasing popularity of electronic devices, usage frequencies of the electronic devices are higher and higher, for example mobile phones, tablet computers, etc. In a usage process, an interface circuit function will be changed from a simple charging function or a data transmission function into a two-in-one function condition. With a fast charging technology being going to continue being popularized, a performance requirement of a contact terminal of a high-frequency, high-pressure resistance and high-current connector component interfaces connector component interface is gradually improved. The connector component interface is often interconnected with a data line, in insertion and withdrawal processes between the connector component interface and the data line, the connector component interface is often touched by a hand, so after a long time use of the connector component interface, the contact terminal in the connector component interface is easily suffered from an environment corrosion, an electrical corrosion and abrasions, and then usage lives of the electronic devices are affected.

Therefore, it is necessary to provide a plated product which is a contact terminal and a method of manufacturing the plated product, so that an electronic device equipped with the plated product may have a corrosion resistance performance and an abrasion resistance performance, and a usage life of the plated product may be increased, and then use time of the electronic device is prolonged.

### SUMMARY OF THE INVENTION

An object of the present invention is to provide a plated product. The plated product includes a component and an overall layer plated on a surface of the component. The overall layer includes a copper layer, a nickel layer, a nickel-tungsten layer, an inner golden layer, a palladium layer, an outer golden layer and a rhodium-ruthenium layer. The copper layer is plated on a surface of the component. The nickel layer, the nickel-tungsten layer, the inner golden layer, the palladium layer, the outer golden layer and the rhodium-ruthenium layer are plated on a surface of the copper layer in sequence.

Another object of the present invention is to provide a plated product. The plated product includes a component and an overall layer plated on a surface of the component. The overall layer includes a copper layer, a nickel layer, a nickel-tungsten layer, an inner golden layer, a palladium layer, an outer golden layer and a rhodium-ruthenium layer. The copper layer is plated on a surface of the component. The nickel layer, the nickel-tungsten layer, the inner golden layer, the palladium layer, the outer golden layer and the rhodium-ruthenium layer are plated on a surface of the copper layer in sequence. A total thickness of the overall layer is ranged between 2.4 μm and 17.5 μm.

Another object of the present invention is to provide a method of manufacturing a plated product. Specific steps of the method of manufacturing a plated product are described hereinafter. Prepare a component. Plate a copper layer on a surface of the component. Plate a nickel layer on a surface of the copper layer. Plate a nickel-tungsten layer on a surface of the nickel layer. Plate an inner golden layer on a surface of the nickel-tungsten layer. Plate a palladium layer on a surface of the inner golden layer. Plate an outer golden layer on a surface of the palladium layer. Plate a rhodium-ruthenium layer on a surface of the outer golden layer.

As described above, the overall layer is plated on the surface of the component, the plated product is capable of being used in a current electronic interface of an electronic device, and the current electronic interface may be used to various data connecting cable, such as a USB (Universal Serial Bus) interface, the plated product is capable of being used as an electronic interface of an electronic connector, or the plated product is capable of being used as one of other interfaces of signal transmission devices and conductive devices. Furthermore, the plated product is capable of being used in various equipment, such as mobile phone, notebooks, tablet computers, cameras, computers and other equipment with storage functions. As a result, the electronic device equipped with the plated product may have a corrosion resistance performance and an abrasion resistance performance, and a usage life of the plated product may be increased, and then use time of the electronic device is prolonged.

### BRIEF DESCRIPTION OF THE DRAWINGS

The present invention will be apparent to those skilled in the art by reading the following description, with reference to the attached drawings, in which:

FIG. 1 is a schematic view of a plated product in accordance with the present invention; and

FIG. 2 is a flow chart of a method of manufacturing the plated product of FIG. 1.

### DETAILED DESCRIPTION OF THE PREFERRED EMBODIMENT

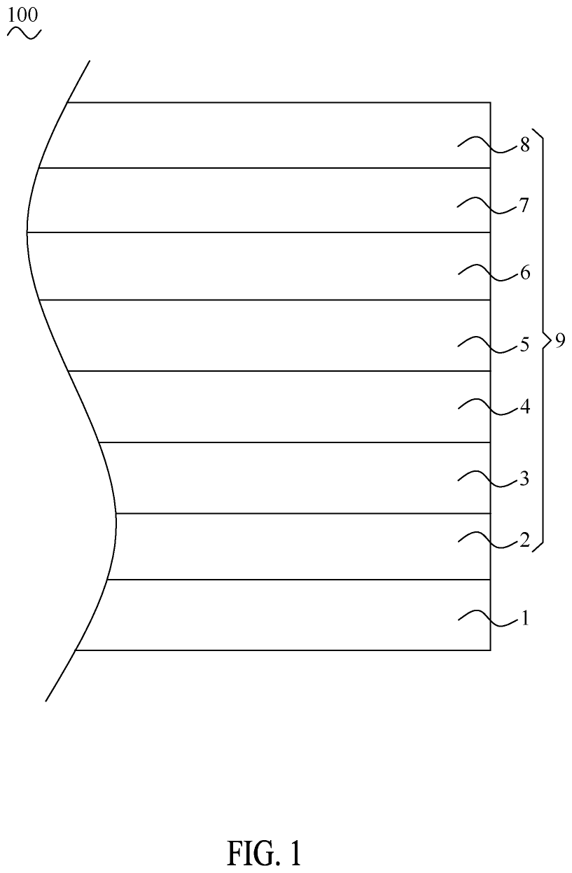

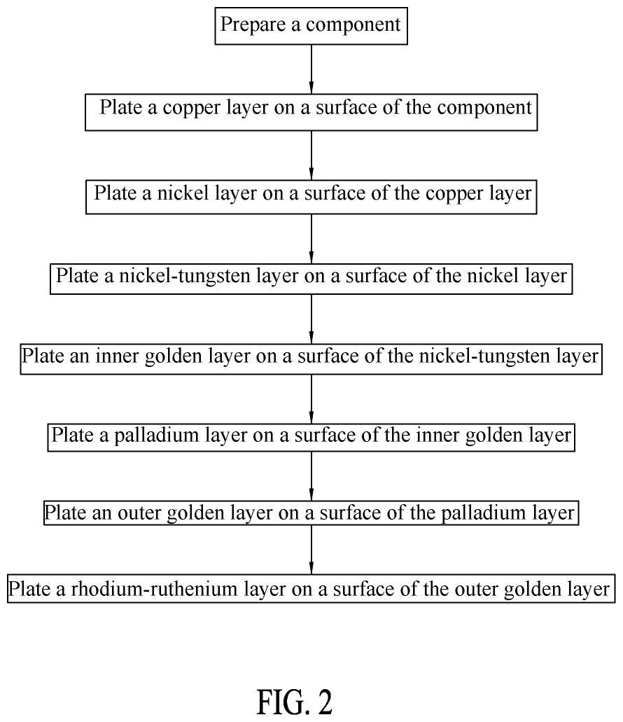

With reference to FIG. 1 and FIG. 2, a plated product 100 and a method of manufacturing the plated product 100 in accordance with a preferred embodiment of the present invention are shown. The plated product 100 includes a component 1, and an overall layer 9 plated on a surface of the component 1. The component 1 is a contact terminal. The overall layer 9 includes a copper layer 2, a nickel layer 3, a nickel-tungsten layer 4, an inner golden layer 5, a palladium layer 6, an outer golden layer 7 and a rhodium-ruthenium layer 8. The copper layer 2 is plated on the surface of the component 1. The nickel layer 3, the nickel-tungsten layer 4, the inner golden layer 5, the palladium layer 6, the outer golden layer 7 and the rhodium-ruthenium layer 8 are plated on a surface of the copper layer 2 in sequence.

Specifically, the nickel layer 3 is plated on a surface of the copper layer 2. The nickel-tungsten layer 4 is plated on a surface of the nickel layer 3. The inner golden layer 5 is plated on a surface of the nickel-tungsten layer 4. The palladium layer 6 is plated on a surface of the inner golden layer 5. The outer golden layer 7 is plated on a surface of the palladium layer 6, and the rhodium-ruthenium layer 8 is plated on a surface of the outer golden layer 7.

The component 1 is made of a copper material for providing a signal transmission performance and an electrical conductivity performance of the component 1. The copper layer 2 is plated on the surface of the component 1 and is capable of being tightly combined with the component 1 for improving a flatness of the component 1 together with the copper layer 2, so a relatively flat overall layer 9 is formed on the surface of the component 1 to avoid a terminal effect and reduce a defect of the overall layer 9. The nickel layer 3 is used for improving a salt spray resistance performance and being provided as a transition layer of the nickel-tungsten layer 4 and the copper layer 2. The nickel-tungsten layer 4 is a nanometer layer with a better abrasion resistance performance and a corrosion resistance performance, especially the nickel-tungsten layer 4 has a nitric acid resistance performance, so that a testing ability of a nitric acid resistance is improved and the abrasion resistance performance is improved. The palladium layer 6 has a larger hardness for improving a hardness of the component 1 and preventing the component 1 from being bent and extended, and an insertion-withdrawal resistance performance of the component 1 is improved. The rhodium-ruthenium layer 8 is capable of improving an electrical contact performance of the component 1. A hardness of the rhodium-ruthenium layer 8 is larger and a contact resistance of the rhodium-ruthenium layer 8 is smaller for improving the nitric acid resistance performance, the abrasion resistance performance and the salt spray resistance performance of the component 1, and simultaneously the component 1 has a better corrosion resistance performance, the insertion-withdrawal resistance performance and a hand sweat electrolysis performance.

The nickel-tungsten layer 4, the palladium layer 6 and the rhodium-ruthenium layer 8 may effectively improve the abrasion resistance performance, the corrosion resistance performance of the component 1, and the hardness and the electrical contact performance of the component 1. The inner golden layer 5 and the outer golden layer 7 are used as transition layers among the nickel-tungsten layer 4, the palladium layer 6 and the rhodium-ruthenium layer 8. Gold has a better ductility, and is capable of buffering or reducing internal stresses of the nickel-tungsten layer 4, the palladium layer 6 and the rhodium-ruthenium layer 8 for preventing that the overall layer 9 generates cracks, so that the overall layer 9 has a better performance. Specifically, the inner golden layer 5 is used for improving the electrical conductivity performance of the component 1 and lowering the inner stresses between the nickel-tungsten layer 4 and the palladium layer 6 so as to improve a combination ability among the inner golden layer 5, the palladium layer 6, the outer golden layer 7 and the rhodium-ruthenium layer 8. The outer golden layer 7 is used for improving a combination force between the palladium layer 6 and the rhodium-ruthenium layer 8 and soldering tin to the component 1.

Specifically, a thickness of the copper layer 2 is ranged between 0.5 μm and 3.5 μm.

Specifically, a thickness of the nickel layer 3 is ranged between 0.5 μm and 2.5 μm.

Specifically, a thickness of the nickel-tungsten layer 4 is ranged between 1 μm and 3.5 μm.

Specifically, a thickness of the inner golden layer 5 is ranged between 0.075 μm and 2.5 μm.

Specifically, a thickness of the palladium layer 6 is ranged between 0.125 μm and 2.0 μm.

Specifically, a thickness of the outer golden layer 7 is ranged between 0.075 μm and 1.0 μm.

Specifically, a thickness of the rhodium-ruthenium layer 8 is ranged between 0.125 μm and 2.5 μm.

So a total thickness of the overall layer 9 is ranged between 2.4 μm and 17.5 μm.

Specific steps of the method of manufacturing the plated product 100 are described as follows.

Prepare the component 1.

Plate the copper layer 2 on the surface of the component 1.

Plate the nickel layer 3 on the surface of the copper layer 2.

Plate the nickel-tungsten layer 4 on the surface of the nickel layer 3.

Plate the inner golden layer 5 on the surface of the nickel-tungsten layer 4.

Plate the palladium layer 6 on the surface of the inner golden layer 5.

Plate the outer golden layer 7 on the surface of the palladium layer 6.

Plate the rhodium-ruthenium layer 8 on the surface of the outer golden layer 7.

As described above, the overall layer 9 is plated on the surface of the component 1, the plated product 100 is capable of being used in a current electronic interface of an electronic device, and the current electronic interface may be used to various data connecting cable, such as a USB (Universal Serial Bus) interface, the plated product 100 is capable of being used as an electronic interface of an electronic connector, or the plated product 100 is capable of being used as one of other interfaces of signal transmission devices and conductive devices. Furthermore, the plated product 100 is capable of being used in various equipment, such as mobile phone, notebooks, tablet computers, cameras, computers and other equipment with storage functions. As a result, the electronic device equipped with the plated product 100 may have a corrosion resistance performance and an abrasion resistance performance, and a usage life of the plated product 100 may be increased, and then use time of the electronic device is prolonged.

What is claimed is:

1. A plated product, comprising:
a component; and
an overall layer plated on a surface of the component, the overall layer including a copper layer, a nickel layer, a nickel-tungsten layer, an inner golden layer, a palladium layer, an outer golden layer and a rhodium-ruthenium layer, the copper layer being plated on a surface of the component, the nickel layer, the nickel-tungsten layer, the inner golden layer, the palladium layer, the outer golden layer and the rhodium-ruthenium layer being plated on a surface of the copper layer in sequence.

2. The plated product as claimed in claim 1, wherein a total thickness of the overall layer is ranged between 2.4 μm and 17.5 μm.

3. The plated product as claimed in claim 1, wherein a thickness of the copper layer is ranged between 0.5 μm and 3.5 μm, a thickness of the nickel layer is ranged between 0.5 μm and 2.5 μm, a thickness of the nickel-tungsten layer is ranged between 1 μm and 3.5 μm, a thickness of the inner golden layer is ranged between 0.075 μm and 2.5 μm, a thickness of the palladium layer is ranged between 0.125 μm and 2.0 μm, a thickness of the outer golden layer is ranged between 0.075 μm and 1.0 μm, and a thickness of the rhodium-ruthenium layer is ranged between 0.125 μm and 2.5 μm.

4. The plated product as claimed in claim 1, wherein the nickel layer is plated on the surface of the copper layer, the nickel-tungsten layer is plated on a surface of the nickel layer, the inner golden layer is plated on a surface of the nickel-tungsten layer, the palladium layer is plated on a surface of the inner golden layer, the outer golden layer is plated on a surface of the palladium layer, and the rhodium-ruthenium layer is plated on a surface of the outer golden layer.

5. A plated product, comprising:
a component; and
an overall layer plated on a surface of the component, the overall layer including a copper layer, a nickel layer, a nickel-tungsten layer, an inner golden layer, a palladium layer, an outer golden layer and a rhodium-ruthenium layer, the copper layer being plated on a surface of the component, the nickel layer, the nickel-tungsten layer, the inner golden layer, the palladium layer, the outer golden layer and the rhodium-ruthenium layer being plated on a surface of the copper layer in sequence;
wherein a total thickness of the overall layer is ranged between 2.4 μm and 17.5 μm.

6. The plated product as claimed in claim 5, wherein a thickness of the copper layer is ranged between 0.5 μm and 3.5 μm, a thickness of the nickel layer is ranged between 0.5 μm and 2.5 μm, a thickness of the nickel-tungsten layer is ranged between 1 μm and 3.5 μm, a thickness of the inner golden layer is ranged between 0.075 μm and 2.5 μm, a thickness of the palladium layer is ranged between 0.125 μm and 2.0 μm, a thickness of the outer golden layer is ranged between 0.075 μm and 1.0 μm, and a thickness of the rhodium-ruthenium layer is ranged between 0.125 μm and 2.5 μm.

7. The plated product as claimed in claim 5, wherein the nickel layer is plated on the surface of the copper layer, the nickel-tungsten layer is plated on a surface of the nickel layer, the inner golden layer is plated on a surface of the nickel-tungsten layer, the palladium layer is plated on a surface of the inner golden layer, the outer golden layer is plated on a surface of the palladium layer, and the rhodium-ruthenium layer is plated on a surface of the outer golden layer.

8. A method of manufacturing a plated product, comprising:
preparing a component;
plating a copper layer on a surface of the component;
plating a nickel layer on a surface of the copper layer;
plating a nickel-tungsten layer on a surface of the nickel layer;
plating an inner golden layer on a surface of the nickel-tungsten layer;
plating a palladium layer on a surface of the inner golden layer;
plating an outer golden layer on a surface of the palladium layer; and
plating a rhodium-ruthenium layer on a surface of the outer golden layer.

9. The method of manufacturing the plated product as claimed in claim 8, wherein a total thickness of an overall layer which includes the copper layer, the nickel layer, the nickel-tungsten layer, the inner golden layer, the palladium layer, the outer golden layer and the rhodium-ruthenium layer is ranged between 2.4 μm and 17.5 μm.

10. The method of manufacturing the plated product as claimed in claim 8, wherein a thickness of the copper layer is ranged between 0.5 μm and 3.5 μm, a thickness of the nickel layer is ranged between 0.5 μm and 2.5 μm, a thickness of the nickel-tungsten layer is ranged between 1 μm and 3.5 μm, a thickness of the inner golden layer is ranged between 0.075 μm and 2.5 μm, a thickness of the palladium layer is ranged between 0.125 μm and 2.0 μm, a thickness of the outer golden layer is ranged between 0.075 μm and 1.0 μm, and a thickness of the rhodium-ruthenium layer is ranged between 0.125 μm and 2.5 μm.
